(19) United States
(12) Patent Application Publication
(10) Pub. No.: US 2003/0081507 A1
(43) Pub. Date: May 1, 2003

(54) Electronic timepiece, display control method for electronic timepiece, and information terminal

(75) Inventor: Isao Kitazawa, Tokyo (JP)

Correspondence Address: FOLEY AND LARDNER, SUITE 500, 3000 K STREET NW, WASHINGTON, DC, 20007, US

(73) Assignee: Citizen Watch Co., Ltd.

(21) Appl. No.: 10/274,382

(22) Filed: Oct. 21, 2002

(30) Foreign Application Priority Data
Oct. 22, 2001 (JP) 2001-323274
Oct. 18, 2002 (JP) 2002-303746

(51) Int. Cl. G04B 19/22

(52) U.S. Cl. 368/21

(57) ABSTRACT

A display section has an information display section, a city display section, and a time difference display section. A mode switch designates information to be displayed in the information display section. A time counter counts a certain time. A desired time zone is designated using a push switch. A time computer calculates a time difference between the counted time and the time in the designated time zone. A display controller controls the display section to display the designated information in the information display section, and the information on the time zone and the information on the time difference in the time difference display section.

### BACKGROUND OF THE INVENTION

1. Field of the Invention

The present invention relates to an electronic timepiece, display control method, and information terminal capable of displaying time difference and other function simultaneously. The electronic timepieces here include electronic clocks and watches.

2. Description of the Related Art

The electronic timepieces are becoming multi-functioned. Apart from measuring and displaying the time, the electronic timepieces have been designed to measure and display various other information.

For example, some electronic timepieces (conventional world-time displayable electronic timepiece) are designed to display names of the major cities in the world and the time in those cities. Some electronic timepieces even have a time difference display function in which a difference in the time in a desired city and the coordinated universal time (UTC) can be displayed.

In the conventional world-time displayable electronic timepieces, the world time difference can not be displayed when some other function is being used. As a result, many disadvantages appear when various functions provided in the electronic timepiece are employed while confirming the world time difference.

For example, a passenger boarding an airplane may want to measure the flight time using a chronograph while checking the time difference between the current time and the time at the destination or time difference between the destination and the UTC. Similarly, the passenger may want to confirm the remaining flight time using a timer while checking the time difference between the current time and the time at the destination or time difference between the destination and the UTC. However, this is not possible in the conventional world-time displayable electronic timepieces, because, they can not display the time difference while some other function (e.g., timer) is being used. It should be noted that this problem is not limited to a passenger boarding an airplane, but the same problem occurs with a passenger riding a car or a train and traveling through different cities (countries) with time-zone differences.

It is often desired to confirm the time difference while a function of the measurement system is being employed, which is not possible in the conventional electronic timepiece. A series of complicated operations, such as switching of displays, are required to be performed in the conventional electronic timepiece to confirm both of the information.

### SUMMARY OF THE INVENTION

It is an object of the present invention to provide a technology that allows an operator to confirm information in a desired mode while confirming a time difference between a certain time, including the coordinated universal time and a home time (a time at the present location), and a time at a designated zone. Particularly, it is an object of the present invention to provide an electronic timepiece, display control method for the electronic timepiece, and an information terminal.

According to one aspect of the present invention, the electronic timepiece has a display unit that has a first display area and a second display area, a display information designation unit that designates information to be displayed in the first display area, and a zone designation unit that designates a desired time zone. Moreover, a time counter unit counts a time, and a time difference computation unit calculates information on a time difference between the time counted by the time counter unit and a time in the time zone. A display control unit controls the display unit to display the information designated by the display information designation unit in the first display area and the information on the time difference calculated by the time difference computation unit in the second display area. As a result, it is possible to display the designated information and the time difference informationimultaneously in the electronic timepiece.

The information designated by the display information designation unit includes information on a function of a measurement system such as a chronograph function and/or a timer function.

The time counter unit may be designed to count the local time or the coordinated universal time or any other time.

According to another aspect of the present invention, the display control method receives indication of which display information is to be displayed in a first display area in a display unit of the electronic timepiece and a time zone, calculates information on a time difference between a time counted in a time counter of the electronic timepiece and a time in the indicated time. Moreover, the display information is displayed in the first display area, and the information on the time difference is displayed in a second display area in the display unit. As a result, it is possible to display the designated information and the time difference informationimultaneously in the electronic timepiece.

According to still another aspect of the present invention, the information terminal has same construction as the electronic according to the present invention. As a result, it is possible to display the designated information and the time difference informationimultaneously in the information terminal.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of the internal construction of an electronic timepiece according to an embodiment of the present invention,

FIG. 2 is a top view of display contents of the electronic timepiece according to the embodiment,

FIG. 3 is a top view of another display content of the electronic timepiece according to the embodiment,

FIG. 4 is a top view of still another display content of the electronic timepiece according to the embodiment,

FIG. 5 is a top view of still another display content of the electronic timepiece according to the embodiment,

FIG. 6 is a flowchart that shows an operation of a time computer 14 in the electronic timepiece according to the embodiment, and

FIG. 7 is a flowchart that shows an operation of a display controller 18 in the electronic timepiece according to the embodiment.

### DETAILED DESCRIPTIONS

An embodiment of the electronic timepiece, the display control method, and the information terminal according to the present invention is explained in detain with reference to the accompanying drawings.

Construction of the Electronic Timepiece The construction of the electronic timepiece according to an embodiment of the present invention is explained first.

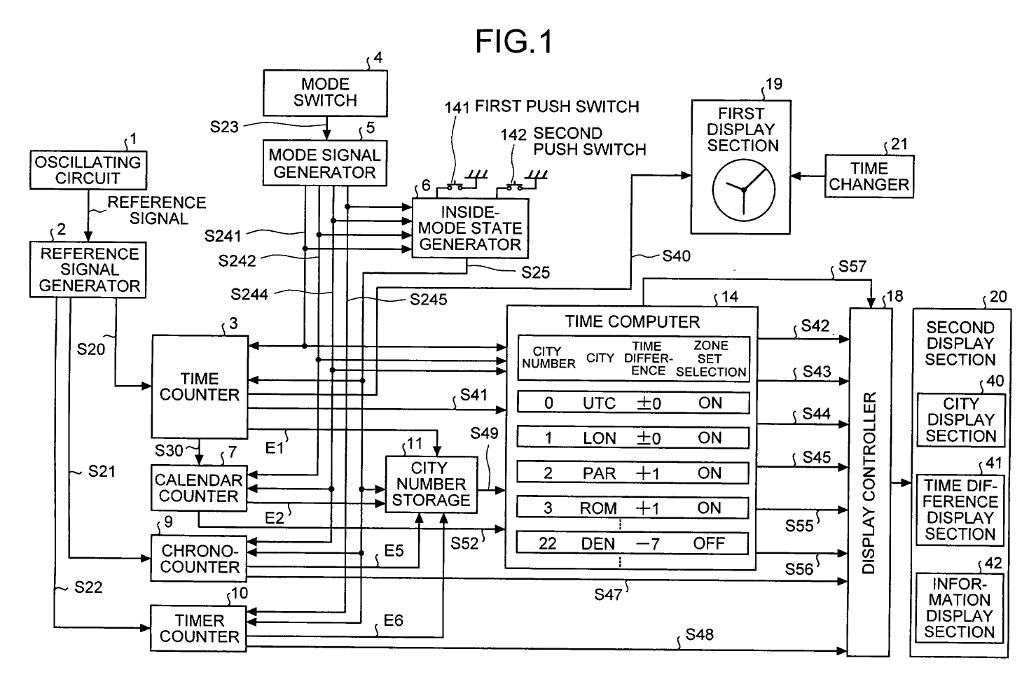

FIG. 1 is a block diagram that shows the construction of the electronic timepiece. An oscillating circuit 1 outputs an oscillation signal. A reference signal generator 2 separates the oscillation signal into a time reference signal S20, a chrono-reference signal S21, and a timer reference signal S22.

A time counter 3 receives the time reference signal S20, calculates and outputs analog time information40, digital time information41, a calendar stepping signal S30, and an enable signal E1 for enabling a city number storage 11. The time counter 3 generally counts the UTC, however, it may be designed to count a time other than the UTC, such as a home time. Moreover, the home time may be the UTC. The time counter 3 can be controlled based on an inside-mode state signal S25 output from an inside-mode state generator 6.

A calendar counter 7 receives the calendar stepping signal S30 output from the time counter 3, and outputs calendar information52, and an enable signal E2 for enabling the city number storage 11.

A chrono-counter 9 receives the chrono-reference signal S21 output from the reference signal generator 2, and outputs an enable signal E5 for enabling the city number storage 11 and a chrono-display signal S47. The chrono-counter 9 is operative to achieve a stopwatch function, that starts time counting when a first push switch 141 is operated and terminates the time counting when the first push switch 141 is operated again, to display a time period until the termination. When the first push switch 141 is operated again, the time counting is started again subsequently. When a second push switch 142 is operated after completion of the time counting, the displayed time is reset. When the second push switch 142 is operated before completion of the time counting, a lap time is measured and displayed.

A timer counter 10 receives the timer reference signal S22 output from the reference signal generator 2, and outputs an enable signal E6 for enabling the city number storage 11 and a timer display signal S48. The timer counter 10 counts down a pre-determined time to display a remaining time. It starts the countdown when the first push switch 141 is operated and halts the countdown when the first push switch 141 is operated again, to display a time period until the halt. When the first push switch 141 is operated once again, the countdown is started subsequently.

A first display section 19 displays a time based on the analog time information40 output from the time counter 3. The first display section 19 analog-displays a time using an hour and a minute hand. A second-hand may or may not be provided. The first display section 19 may digital display instead of the analog display. A time changer 21 changes a time displayed in the first display section 19. Specifically, the time changer 21 is the stem for moving the hour hand. A first push switch 141 and a second push switch 142 each performs a switching operation associated with an external member (button).

The operator can select a desired information display mode by operating a mode switch 4. The mode switch 4 outputs a mode switch signal S23 when it is operated.

A mode signal generator 5 receives the mode switch signal S23 output from the mode switch 4 and outputs a time mode signal S241, a calendar mode signal S242, a chrono-mode signal S244, and a timer mode signal S245.

An inside-mode state generator 6 receives the time mode signal S241, the calendar mode signal S242, the chrono-mode signal S244, and the timer mode signal S245 output from the mode signal generator 5. The inside-mode state generator 6 outputs an inside-mode state signal S25 to control an inside-mode state corresponding to each of a time mode, a calendar mode, a chrono-mode, and a timer mode.

The city number storage 11 is enabled with either one of the enable signal E1 output from the time counter 3, the enable signal E2 output from the calendar counter 7, the enable signal E5 output from the chrono-counter 9, and the enable signal E6 output from the timer counter 10. The city number storage 11 outputs a time city number signal S49 to a time computer 14 based on the inside-mode state signal S25 output from the inside-mode state generator 6.

The time computer 14 includes a time difference computer. The time computer 14 receives the digital time information41 output from the time counter 3, the calendar information52 output from the calendar counter 7, and the time city number signal S49 output from the city number storage 11. Based on these signals, the time computer 14 selects a city (or country), calculates the time in that city, and a time difference between the time in that city and the UTC time. The time computer 14 outputs a time display signal S44, a city display signal S43, a time difference display signal S42, a calendar display signal S45, a “+” sign signal S55, a “−” sign signal S56, and a “±” sign signal S57 based on the result of calculations. The “±” sign signal S57 is employed to attach a plus/minus sign when the time difference is 0. The “±” sign may be added before or after the digits.

A display controller 18 receives the time difference display signal S42, the city display signal S43, the time display signal S44, the calendar display signal S45, the “+” sign signal S55, the “−” sign signal S56, and the “±” sign signal S57 output from the time computer 14, the chrono-display signal S47 output from the chrono-counter 9, and the timer display signal S48 output from the timer counter 10. The display controller 18 controls the second display section 20 based on the received signals.

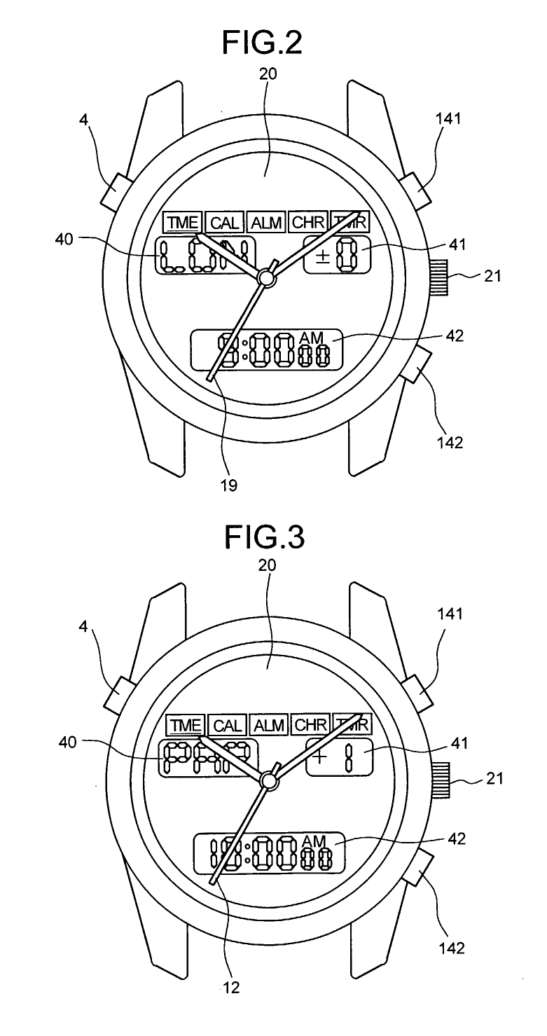

The second display section 20 includes a city display section 40, a time difference display section 41, and an information display section 42 to digital-display the display contents. The city display section 40 displays the name of the city (or the country) indicated by the city display signal S43. The city name or the country name may be displayed with three alphabets as shown in FIGS. 2 to 5.

The city name can be displayed, specifically as shown in FIG. 2, using generally employed aberrations, such as “UTC” for the coordinated universal time, “LON” for London, “PAR” for Paris, and “ROM” for Rome. If no time difference is present within a country such as Japan, the name of the country may be displayed instead of the city name. Specifically, “JPN” may be employed for indicating Japan. Such three alphabet aberration can be employed to identify zone names with a limited number of characters.

A time difference display section 41 displays a time difference based on the time difference display signal S42. The time difference display section 41 displays digits that indicate the time difference. For example, when “3” is displayed, it means that the time difference is three hours. If the time difference display section 41 displays a time difference of 0 (zero), this time difference may be confused with “0” at the chrono-hour figure. Therefore, if the city number is “0” or “1”, or the time difference is 0 hour, the “±” sign signal S57 is output to add a “±” sign to display the time difference of “0 hour” as “±0” in the time difference display 41. The “±” sign may be added at the end, such as “0±”, of the digit. Thus, “the time difference of 0 hour” can be prevented from being confused with “0 hour at the chrono-hour figure”.

The information display section 42 displays information on a time and so forth. It displays a time, a calendar, a chrono-minute figure, a chrono-second figure, a chrono-1/10 figure, and a chrono-1/100 figure, based on the time display signal S44, the calendar display signal S45, the chrono-display signal S47, and the timer display signal S48.

Operations of the Electronic Timepiece

How the electronic timepiece according to the embodiment operates is explained next.

FIGS. 2 to 5 are top views that show different display contents of the electronic timepiece according to the embodiment. In FIGS. 2 to 5, the first display section 19 at any time indicates a time based on the analog time information output from the time counter 3 with hour, minute, and second hands. The digital time information is at any time is output from the time counter 3 to the time computer 14.

The time computer 14 receives the time mode signal S241, the calendar mode signal S242, and the chrono-mode signal S244 output from the mode signal generator 5. The time computer 14 outputs desired display signals selected from the time display signal S44, the calendar display signal S45, the city display signal S43, and the time difference display signal S42. The second display section 20 displays information in the city display section 40, the time difference display section 41, and the information display section 42.

The city display section 40 and the time difference display section 41 are located side-by-side as shown in FIG. 2. Specifically, the city display section 40 is located at the left side of the time difference display section 41. In this case, the city display section 40 and the time difference display section 41 are two individual areas. Therefore, they can be arranged laterally sandwiching axes of hour-, minute- and second-hands between them. Instead of the two individual areas, the right side part of one area may be employed for the time difference display section 41 and the left side part for the city display section 40.

An example is explained with reference to FIGS. 1 and 2 when the second display section 20 performs the time mode display, assuming “1” for a city number in the city number storage 11, and “9:00′00″ A.M.” for the time counter 3 in FIG. 1.

In FIG. 1, through the selection by the mode switch 4, the mode signal generator 5 outputs the time mode signal S241. As a result, the inside-mode state generator 6, the time counter 3, and the time computer 14 select the time mode to control each part in the time mode. On reception of the time mode signal S241, the time counter 3 outputs the enable signal E1 to enable the city number storage 11.

The city number storage 11 thus enabled outputs the time city number signal S49. The content of the time city number signal S49 includes the city number of “1” stored in the city number storage 11. Based on the city number of “1” output from the city number storage 11, the city with the corresponding number, “LON”, is selected, and the time difference is calculated as “0”. The time difference “0” may be previously registered so that the registered information can be selected. This is effective to prevent the time difference from being calculated every time.

As shown in FIG. 2, when the city display signal S43 is output, “LON” is displayed in the city display section 40. When the time difference display signal S42 is output, “0” is displayed in the time difference display section 41. The information, “9:00′00″ A.M.”, in the digital time information41 is added to the time difference “0” at the selected city to output the result, “9:00′00″ A.M.”, to the time display signal S44, displayed in the information display section 42.

An example is explained with reference to FIG. 1 and the top view shown in FIG. 3 when the city intended to display the time difference can be changed. The city can be changed through the operations of the first push switch 141 and the second push switch 142.

If it is desired to change the displayed time difference upward, the first push switch 141 is operated. In FIG. 1, every time the first push switch 141 is operated, the inside-mode state generator 6 outputs the inside-mode state signal S25 to control the time difference to be changed upward relative to the UTC time. Based on the inside-mode state signal S25, the city number storage 11 increments the stored city number by one and outputs the time city number signal S49. Based on a new city number of “2” calculated from the time city number signal S49, the time computer 14 selects the city with the corresponding number, “PAR”, and calculates the time difference, “+1”, then outputs the city display signal S43.

As shown in FIG. 3, the display controller 18 displays “PAR” in the city display section 40 and outputs the time difference display signal S42 and the “+” sign signal S55 to display “+1” in the time difference display section 41. The information, “9:00′00″ A.M.”, in the digital time information41 is added to the time difference “+1” at the selected city to output the result, “10:00′00″ A.M.”, to the time display signal S44. Thus, the display controller 18 displays “10:00′00″ A.M.” in the information display section 42.

The displayed time difference can be changed also downward if it is desired. An example of this case is explained, assuming “2” for the city number storage 11, and “10:00′00″ A.M.” for the time counter 3.

If it is desired to change the city display in the down-direction, the second push switch 142 is operated once while the first push switch 141 is continuously pressed for 1 to 1.5 seconds. As a result, the direction of the city selection is switched to allow the city selection to be performed downward. Thereafter, every time the first push switch 141 is operated, the inside-mode state generator 6 outputs the inside-mode state signal S25. Based on the inside-mode state signal S25, the city number storage 11 decrements the stored city number by one and outputs the time city number signal S49.

The time computer 14 receives the time city number signal S49 and, based on a new calculated city number of “1”, selects the city with the corresponding number, “LON”. The time computer 14 then calculates the time difference “0” and outputs the city display signal S43. As shown in FIG. 2, the display controller 18 displays “LON” in the city display section 40. The time computer 14 outputs the time difference display signal S42. The display controller 18 displays “0” in the city display section 40. The information, “9:00′00″ A.M.”, in the digital time information41 that is the UTC time is added to the time difference “0” at the selected city to output the result, “9:00′00″ A.M.”, to the time display signal S44, displayed in the information display section 42.

Thus, in the time mode, the city can be displayed in the city display section 40, the time difference in the time difference display section 41, and the time at the selected city in the information display section 42.

An example is explained when the second display section 20 performs the calendar mode display. The same city number as that in the previous time mode is stored in the city number storage 11 because it is employed similar to the time mode. The following example is explained assuming “2” for the city number, “11:30 P.M.” for the time counter 3, and January 1 for the calendar counter 7.

Through the operation of the mode switch 4, the mode signal generator 5 outputs the calendar mode signal S242 (see FIG. 1). As a result, the inside-mode state generator 6, the calendar counter 7, and the time computer 14 select the calendar mode to control each part in the calendar mode. Based on the calendar mode signal S242, the calendar counter 7 outputs the enable signal E2 to enable the city number storage 11.

The city number storage 11 thus enabled outputs the time city number signal S49 to the time computer 14. The content of the time city number signal S49 includes the city number of “2” stored in the city number storage 11. . Based on the city number output from the city number storage 11, the time computer 14 selects the city with the corresponding number, “PAR”, and calculates the time difference of “+1”, then outputs the time difference display signal S42 and the “+” sign signal S55 to the display controller 18. On receipt of the time difference display signal S42, the “+” sign signal S55, and the city display signal S43, the display controller 18 displays “+1” in the time difference display section 41 and “PAR” in the city display section 40.

The time difference is added to the information, “11:30 P.M.”, in the digital time information41 output from the time counter 3 and, from the added result, the need for figure-up in day is determined. In this example, it is determined that the figure-up is required. Therefore, based on the information in the calendar information52, the day is incremented by one to display “January 2” in the information display section 42 as a result. The change of the city in the calendar mode is the same as in the time mode and is omitted to explain.

Thus, in the calendar mode, the city can be displayed in the city display section 40, the time difference in the time difference display section 41, and the calendar in the information display section 42. Depending on the usage by the user, as the first display section 19 can display the time, the second display section 20 may be employed in a general use to display the calendar.

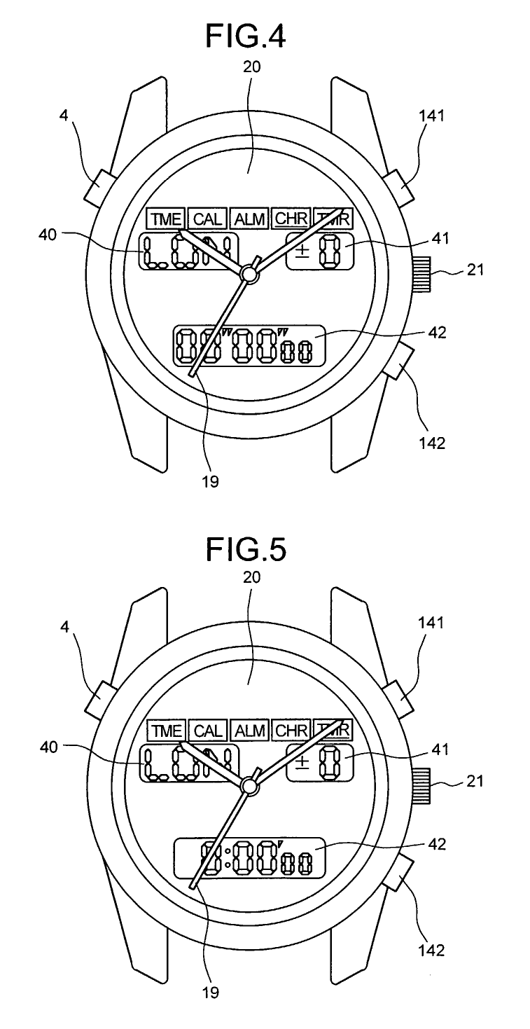

An example is explained with reference to FIGS. 1 and 4 when the second display section 20 performs the chrono-mode display. As a result of the operation of the mode switch 4, the mode signal generator 5 outputs the chrono-mode signal S244. As a result, the inside-mode state generator 6, the chrono-counter 9, and the time computer 14 select the chrono-mode to control each part in the chrono-mode. On reception of the chrono-mode signal S244, the chrono-counter 9 outputs the enable signal E5 to enable the city number storage 11.

Based on the chrono-mode signal S244, the chrono-counter 9 outputs the chrono-display signal S47. Based on the chrono-display signal S47 received, the information display section 42 displays the chrono-minute, the chrono-second, the chrono-1/10 figure, and the chrono-1/100 figure, as shown in FIG. 4.

An example is explained with reference to FIGS. 1 and 5 when the second display section 20 performs the timer mode display. As a result of the operation of the mode switch 4, the mode signal generator 5 outputs the timer mode signal S245. As a result, the inside-mode state generator 6, the timer counter 10, and the time computer 14 select the timer mode to control each part in the timer mode. On reception of the timer mode signal S245, the timer counter 10 outputs the enable signal E6 to enable the city number storage 11.

Based on the timer mode signal S245, the timer counter 10 outputs the timer display signal S48. Based on this timer display signal S48 the information display section 42 displays the timer hour, the timer minute, and the timer second, as shown in FIG. 5.

The measurement system has other functions than the above, for example, measurement of the temperature, measurement of the altitude, measurement of the atmospheric pressure, measurement of the orientation, measurement of the depth of water, measurement of the distance, and measurement of the amount of ultraviolet rays.

Operations of the Time Computer

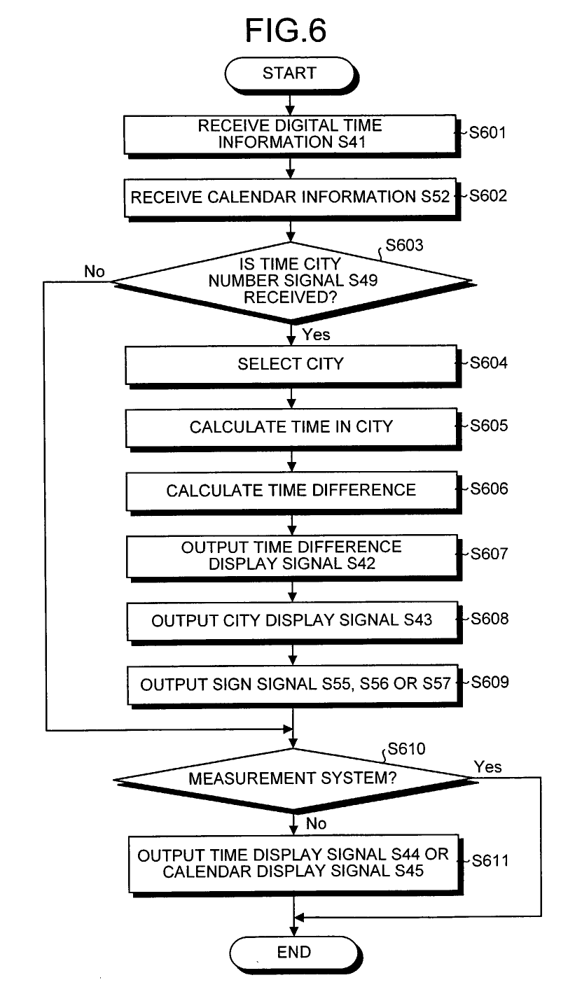

FIG. 6 is a flowchart that shows the operation of the time computer 14. The time computer 14 receives the digital time information41 output from the time counter 3 (step S601), and subsequently receives the calendar information52 output from the calendar counter 7 (step S602).

Then, the time computer 14 determines if the time city number signal S49 is received from the city number storage 11 is entered (step S603). If the time city number signal S49 is received, then the time computer 14 selects a city based on the time city number signal S49 (step S604). As the city corresponds to the city number, if the city number can be identified based on the time city number signal S49, the city name can be selected.

The time computer 14 calculates the time in the selected city (step S605). The time computer 14 calculates the time difference in the selected city and the UTC time (step S606). The time difference can be calculated as a finite difference between the time at the city calculated at the step S605 and the UTC time. It is also decided whether the time difference is plus or minus.

The time computer 14 outputs the results of the calculated at the step S606 to the display controller 18 in the form of the time difference display signal S42 (step S607). The time computer 14 informs the city selected at the step S604 to the display controller 18 in the form of the city display signal S43 (step S608). Moreover, the time computer 14 outputs information that indicates whether the time difference is plus or minus or zero. Precisely, the time computer 14 outputs the “+” sign signal S55 when the time difference is plus, outputs the “−” sign signal S56 when the time difference in minus, and outputs the “±” sign signal S57 (step S609) when the time difference is zero.

If it is determined at the step S603 that the time city number signal S49 is not received, that means the operator does not want the time difference to be displayed. In that case, the control jumps to the step S610.

Based on the signal output from the mode signal generator 5, the time computer 14 decides if the information to be displayed in the information display section 42 is the information on the function of the measurement system (step S610). If it is not the information on the function of the measurement system, it is required to provide the display controller 18 with the information to be displayed in the information display section 42. In that case, based on the input mode signal (the time mode signal S241 or the calendar mode signal S242), the time computer 14 outputs the time display signal S44 or the calendar display signal S45 to the display controller 18, and ends the process.

On the other hand, if in step S610 it is decided that the information is the information on the function of the measurement system, that is, if the signal output from the mode signal generator 5 is the chrono-mode signal S244 or the timer mode signal S245, then the time computer 14 ends the process. In this case, the time computer 14 does not output a signal because the chrono-display signal S47 or the timer display signal S48, on which the time computer 14 has no control, is input into the display controller 18.

Operations of the Display Controller

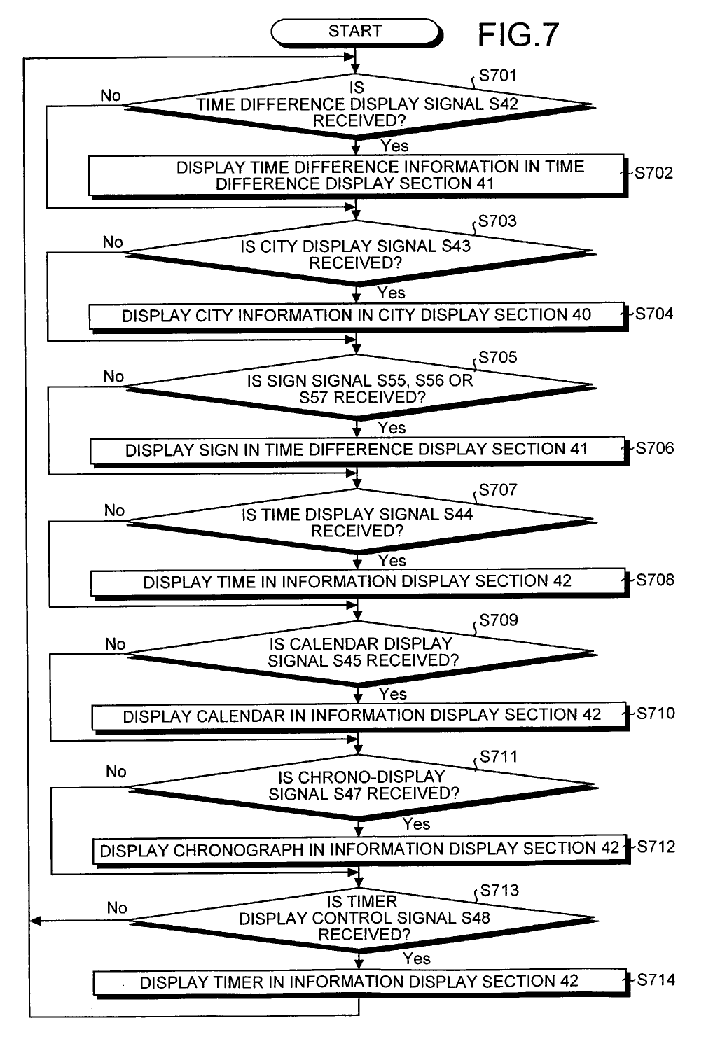

FIG. 7 is a flowchart that shows an operation of the display controller 18. The display controller 18 determines if the time difference display signal S42 output from the time computer 14 is received (step S701). If the time difference display signal S42 is input, the display controller 18 displays the time difference information in the time difference display section 41 in the second display section 20 based on the time difference display signal S42 (step S702). If the time difference display signal S42 is not received, the display controller 18 performs the process in step S703.

In the same manner, display controller 18 determines if the city display signal S43 is received (step S703) and displays the city in the city display section 40 (step S704). The display controller 18 determines if the sign signal S55, S56, or S57 is received (step S705) and displays the sign in the time difference display section 41 (step S706). The display controller 18 determines if the time display signal S44 is received (step S707) and displays time in the information display section 42 (step S708). The display controller 18 determines if the calendar display signal S45 is received (step S709) and displays the calendar in the information display section 42 (step S710). The display controller 18 determines if the chron-display signal S47 is received (step S711) and chronograph in the information display section 42 (step S712). Finally, the display controller 18 determines if the timer display control signal S48 is received (step S713) and displays timer in the information display section 42 (step S714).

The display controller 18 repeatedly executes the steps S701 to S714 each time a new display signal is entered. As a result, information corresponding to that signal is displayed in the corresponding display section.

In response to the output from the inside-mode state generator 6, the time city number signal S49 output from the city number storage 11 changes. Every time it changes, the time difference display signal S42, the city display signal S43, and the sign signal (S55, S56 or S57) output from the time counter 14 are newly entered into the display controller 18. Based on these signals, the information to be displayed in the time difference display section 41 and the city display section 40 are changed (steps S702, S704, S706).

Similarly, in response to the output from the inside-mode signal generator 5, either one of the mode signals (S241, S242, S244, S245) is newly output. Every time it is newly output, either one of the time display signal S44, the calendar display signal S45 output from the time counter 14, the chrono-display signal S47 output from the chrono-counter 9, or the timer display signal S48 output from the timer counter 10 is newly entered into the display controller 18. Based on the signal, the information to be displayed in the information display section 42 is changed (steps S708, S710, S712, S714). Thus, it can be observed that the contents displayed in the information display section 42 are switched every time when the mode switch 4 is operated.

As explained above, according to the present embodiment, the second display section 20 has the information display section 42 as the first display area and the time difference display section 41 as the second display area. The mode switch 4 designates the information (mode) to be displayed in the information display section 42. The time counter 3 counts a certain time. The push switches 141, 142 designate a desired zone. The time computer 14 calculates the information on the time difference between the time counted at the time counter 3 and the time at the zone designated by the push switches 141, 142. The display controller 18 controls the second display section 20 to display the information designated at the mode switch 4 in the information display section 42 and the information on the time difference calculated at the time computer 14 in the time difference display section 41. Therefore, the designated information and the time difference information can be displayed at the same time.

When the information (mode) on the function of the measurement system is designated, the time difference information can be displayed together with the information on the additional function simultaneously, particularly including the information on the function of the measurement system, such as the information on the chronograph and the information on the timer.

As the time counter 3 counts the coordinated universal time, a time difference from the coordinated universal time can be displayed. As the time counter 3 can also count a time other than the coordinated universal time, a time difference can be displayed from a time other than the coordinated universal time, for example, a home time. The push switches 141, 142 or the time designation unit can be employed to designate a time other than the coordinated universal time to designate a time as the reference to the time difference.

The display controller 18 indicates the information on the time difference, as shown in FIGS. 2 to 5, using numerals with a plus or minus sign. Therefore, according to the present invention, the time difference can be indicated much simply. Similarly, the display controller 18 indicates the information on the time difference when the time difference is zero, as shown in FIG. 4, using a numeral of “0” with a sign of “±”. Therefore, the information on the time difference when the time difference is zero can be indicated definitely without being confused with other displays.

The display controller 18 controls the second display section 20 to display the information on the designated zone in the city display section 40. Therefore, it is possible to display the time zone together with the information on the time difference.

The second display area 20 has at least two individual areas, as shown in FIGS. 2 to 5, including the city display section 40 that displays the information on the designated zone, and the time difference display section 41 that displays the information on the calculated time difference. These two areas can be arranged at optimum locations, spacing from axes of hour-, minute- and second-hands. The city display section 40 and the time difference display section 41 are arranged laterally. Therefore, it is possible to display both pieces of informationo that anyone can confirm them instantaneously without moving a line of sight. The city display section 40 is located at the left side of the time difference display section 41. Therefore, the zone information can be confirmed first and subsequently the time difference information when the information is confirmed along its flow because information is written from left to right in sideways writing.

The information displayed in the city display section 40 expresses a zone name with three alphabets. Therefore, it is possible to display the zone informationo that it can be confirmed efficiently with the minimum amount of information.

The first display section 19, which displays the time, is different from the second display section 20, which displays the other information. Therefore, it is possible to display a certain time in addition to the designated information and the time difference information. The analog display enables the time to be identified intuitively based on locations of hands. The time displayed in the time display unit can be changed. Therefore, it is possible to display a desired time.

In the embodiment, the display area that displays the time difference information and the display area that displays various pieces of information are provided as individual areas to display both pieces of informationimultaneously as a non-limited arrangement example. For example, the display area that displays the time difference information and the display area that displays various pieces of information are provided as the same display area to display both pieces of information alternately by switching them at a certain time interval (for example, every second). This is effective to allow the operator to efficiently identify the designated information and the time difference information even in the limited display area.

In the embodiment, the mode switch 4, serving as the display information designation unit that designates the information to be displayed in the mode or information display section 42, is configured by a different member from those of the push switches 141, 142, serving as the zone designation unit that designates the zone to be displayed in the city display section 40, as a non-limited example. For example, the two units may be configured using a single switch member. In this case, the switch member is operated in different methods. Specifically, the time for continuously pressing the switch or the number of pressing the switch may be applied to identify the designation type. If the stem is employed, a difference in the rotational direction may be applied to identify the designation type.

In the embodiment, the electronic timepiece is explained though the present invention is applicable to a wristwatch and a table-timepiece. It is not limited to the electronic timepiece. For example, it may be applied to mobile information terminals such as cell phones, PDAs (personal digital assistant), note-type personal computers and various measurement devices.

As explained above, the present invention is effective to provide an electronic timepiece, display control method for the electronic timepiece, and information terminal, that allows an operator to confirm information in a desired mode while confirming a time difference between a certain time, including the coordinated universal time and a home time (a time at the present location), and a time at a designated zone.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An electronic timepiece, comprising:
a display unit that has a first display area and a second display area;
a display information designation unit that designates information to be displayed in the first display area;
a time counter unit that counts a time;
a zone designation unit that designates a desired time zone;
a time difference computation unit that calculates information on a time difference between the time counted by the time counter unit and a time in the time zone designated by the zone designation unit; and
a display control unit that controls the display unit to display the information designated by the display information designation unit in the first display area and the information on the time difference calculated by the time difference computation unit in the second display area.

2. The electronic timepiece according to claim 1, wherein the information designated by the display information designation unit includes information on a function of a measurement system.

3. The electronic timepiece according to claim 2, wherein the information on the function of the measurement system includes information on a chronograph function.

4. The electronic timepiece according to claim 2, wherein the information on the function of the measurement system includes information on a timer function.

5. The electronic timepiece according to claim 1, wherein the time counter unit counts the coordinated universal time.

6. The electronic timepiece according to claim 1, wherein the time counter unit counts a time other than the coordinated universal time.

7. The electronic timepiece according to claim 6, further comprising a time designation unit that designates a time other than the coordinated universal time, wherein the time counter unit counts a time designated by the time designation unit.

8. The electronic timepiece according to claim 1, wherein the display control unit employs a numeral with a plus or minus sign to display the information on the time difference.

9. The electronic timepiece according to claim 8, wherein the display control unit displays a digit 0 (zero) with a ± (plus-minus) sign to display the information on the time difference if the time difference is zero.

10. The electronic timepiece according to claim 1, wherein the display control unit controls the display unit to display in the second display area the information on the time zone in addition to the information on the time difference.

11. The electronic timepiece according to claim 1, wherein the first display area and the second display area share a display area in the display unit so that the information to be displayed in the first display area and the information to be displayed in the second display area are switched and displayed in the shared display area.

12. The electronic timepiece according to claim 10, wherein the second display area has two laterally located separate display areas, one of the display area displays the information on the time zone, and the other display area displays the information on the time difference.

13. The electronic timepiece according to claim 12, wherein, in the second display area, the display area that displays the information on the time zone is located at the left side of the display area that displays the information on the time difference.

14. The electronic timepiece according to claim 10, wherein the information on the time zone is a name of one of the world time zones and it is expressed with three alphabets.

15. The electronic timepiece according to claim 1, further comprising a time display unit that displays the time counted by the time counter unit, wherein the time display unit and the display unit are separate units.

16. The electronic timepiece according to claim 15, wherein the time display unit is an analog display.

17. A display control method for an electronic timepiece, comprising:
receiving indication of which display information is to be displayed in a first display area in a display unit of the electronic timepiece;
receiving indication of a time zone;
calculating information on a time difference between a time counted in a time counter of the electronic timepiece and a time in the indicated time; and
displaying the display information in the first display area, and displaying the information on the time difference in a second display area in the display unit.

18. The display control method according to claim 17, wherein the display information includes information on a function of a measurement system.

19. The display control method according to claim 17, further comprising displaying, in the second display area, the information on the time zone in addition to the information on the time difference.

20. An information terminal, comprising:
a display unit that has a first display area and a second display area;
a display information designation unit that designates information to be displayed in the first display area;
a time counter unit that counts a time;
a zone designation unit that designates a desired time zone;
a time difference computation unit that calculates information on a time difference between the time counted by the time counter unit and a time in the time zone designated by the zone designation unit; and
a display control unit that controls the display unit to display the information designated by the display information designation unit in the first display area and the information on the time difference calculated by the time difference computation unit in the second display area.
